(19) United States
(12) Patent Application Publication
(10) Pub. No.: US 2012/0092265 A1
(43) Pub. Date: Apr. 19, 2012

(54) Apparatus for retrieval, storage, and display of data from data recording systems

(75) Inventors: Janet E. Williams, Santa Paula, CA (US); Budd T. Pohle, Camarillo, CA (US)

(73) Assignee: CARGO DATA CORPORATION, Ventura, CA (US)

(21) Appl. No.: 12/931,301

(22) Filed: Jan. 28, 2011

Related U.S. Application Data
(60) Provisional application No. 61/337,320, filed on Feb. 1, 2010.

(51) Int. Cl. G06F 3/02; G06F 3/041; G06F 3/01

(52) U.S. Cl. 345/169; 345/156; 345/173

(57) ABSTRACT

A handheld portable apparatus adapted for retrieval, display and transfer of data in association with data recording systems such as are common in the container transport industry. A control and display module affords user interaction. Operable connection of a data recording system device initiates data collection, processing operations, visual display, alerts and storage of data sets, allowing selected communication with remote systems.

### CROSS-REFERENCE TO RELATED APPLICATIONS

This application claims the benefit of and priority to prior filed co-pending U.S. Provisional Patent Application Ser. No. 61/337,320, filed on Feb. 1, 2010, the disclosure of which is incorporated herein by reference.

### STATEMENT REGARDING FEDERALLY SPONSORED RESEARCH OR DEVELOPMENT

Not Applicable.

### THE NAMES OF THE PARTIES TO JOINT RESEARCH OR DEVELOPMENT

Not Applicable.

### BACKGROUND OF THE INVENTION

1. Field of the Invention

The present invention relates generally to the field of environmental monitoring and recording systems and, more particularly, to devices for retrieving, storing, and displaying information obtained from environmental monitoring and recording devices used to monitor the environmental conditions of goods over a period of time, such as during shipment or storage. Such devices are hereinafter referred to as apparatus for retrieving data sets from data recording devices.

2. Description of the Related Art

There exist many types of products that are very sensitive to the conditions of the surrounding environment. Commonly, temperature is an environmental parameter that must be controlled during transport or storage. Examples of temperature-sensitive items include medical and pharmaceutical products, biological materials, and produce and other foodstuffs. Monitoring of such products during shipment or transport can provide desirable assurance that appropriate environmental conditions such as temperature, humidity, etc. were maintained.

To meet this need, a range of devices or systems have been developed to monitor and record desired environmental parameter values during a period of time. Accordingly, temperature monitoring and recording devices are well known in the art and are commonly used to track the environmental conditions, such as temperature, experienced by the product.

Typically, a temperature-monitoring device, a type of data recorder system, is placed inside a temperature-controlled shipping container by the shipping party. After the container has been transported, the receiving party retrieves the temperature-monitoring device when the container is opened upon delivery.

Devices commonly found in use today provide for attachment to a desktop computer or printer to print out a record of monitored conditions during shipment. A receiving party must take the recovered data logger to a computer station and dedicated printer in order to view the recorded data and determine if the shipment is acceptable or not.

While there are a number of benefits afforded by the use of such monitoring devices and systems, the real world conditions of containerized shipping operations render the current practice inconvenient, time-consuming, and inefficient. Frequently, data logger units are recovered from these monitored shipments at a receiving and distribution center. A great number of shipping containers are received at these locations in the course of a single day. The loading/offloading area is busy with many shipping containers, forklifts, employees, delivery drivers, etc.

For each arriving container, the monitoring device must be located and recovered for verification of conditions during transport. The data logger device has to be carried from the shipping container to a computer and printer station in order for the shipment receiving station to get access to a complete record of the data recorded by the data logger. The data logger printout must then be returned to the shipping/receiving area and manually associated with the documentation of the particular shipment.

With routine business, a receiving station is soon inundated with paper as data printouts accumulate from the large number of arriving shipping containers. Workers waste valuable time and energy transporting the monitoring devices back and forth from the receiving area to the printing area and back.

### SUMMARY OF THE INVENTION

In brief, particular arrangements in accordance with the present invention include a portable handheld data retrieval apparatus having a docking section for receiving a monitoring device in operative communication, a control panel having buttons or other control components to facilitate operation, processing capabilities via microprocessor units and memory storage for storing and reporting data obtained from multiple monitoring devices, a visual display for allowing a user to view selected information in a variety of graphical, tabular or other format, and one or more data port to provide compatible connection to a computer or printer for bulk or selected download of stored data.

Additional configurations can provide a portable handheld data retrieval apparatus configured to accept inputting by a user, of selected information for subsequent transmission to a data monitoring/recording system to initiate or define an identifiable interval of interest.

Prior art devices required a user to employ a personal computer having network access to log-in to a remote, third party, server that would transfer the appropriate instructions to the monitoring system through telephone or satellite communications. This method was time-consuming and very inconvenient as the computers are usually in the office and some distance from the loading/unloading dock where the data recording systems are found.

The present invention uniquely addresses these challenges and provides an innovative and inexpensive way for users to have convenient access to information held by data recorders and data recording systems.

To utilize the present invention, a monitoring device, a type of data recorder system, is docked in the docking station by a user, thereby establishing necessary communication. A variety of communication connectors may be provided to achieve this function. A DB-9 serial connector, often identified as an RS-232, has proven effective and popular with industry. USB or mini-USB connectors are gaining in use, and a variety of connectors or data communication protocols are contemplated as within the scope of the present invention. Such connectors may be industry standards or proprietary, as appropriate.

The visual display is preferably a pixilated LCD equipped with backlighting for ease of viewing in low-light conditions, although a variety of visual displays are possible and contemplated within the scope of the present invention. LCMs or segmented LCDs or other displays may be used, with pixilated displays preferred for ability to provide detailed information and/or graphical representation of retrieved data. The visual display may consist of a single display unit or may be combined with other visual display elements to provide greater flexibility and capabilities. Collectively these display elements may provide a user with information relating to status of monitoring devices and retrieved data.

The docking section of the data retrieval unit of the present invention is adapted to receive a monitoring device for transfer of recorded data. This docking section may be effectively recessed into a portion of the data retrieval unit and can be equipped with a flange arrangement or raised perimeter portion with which to assist in guiding insertion and necessary alignment of a selected monitoring device.

Upon placement of a monitoring device, also referred to as a recorder, on the docking section of the data retrieval unit of the present invention, communication is established. Such communication may be wired or wireless. The data retrieval unit obtains information from the subject recorder, performs associated processing, and presents selected information on a display for a user. Accompanying identifiers or codes are recovered and associated with the retrieved records. Identifier codes may be a tracking number, container number, serial number, or other unique code to allow for the accurate and reliable identification of the recorded information. This unique identifier provides for reliable tracking and traceability of gathered data and the materials to which it relates.

The apparatus may proceed to collect information from a number of recorders. The apparatus gathers, analyzes, and stores data collected from any number of recorders. The apparatus analyzes the collected data for values that exceed a desired range, alarm conditions occurred, or any errors detected. In such case, the apparatus alerts the user through visual or audible indicators.

The present invention provides the greater convenience of being able to detect and retrieve data sets from recorder units by way of wireless communications. A user at a loading dock may collect data sets from a large number of data recorders along a loading dock without having to physically retrieve the data recorders from each shipment.

In another embodiment of the present invention, a user is provided opportunity to enter, via keypad, keyboard or other methods of data entry, user-selectable alphanumeric entry of information and data fields to provide ready correspondence with user-specific requirements. Such alpha-number entry capability enables users to identify the logged data with a particular customer, company information, contact or other data, purchase order, vendor, or other useful information.

In another embodiment, the apparatus is provided with wireless or radio frequency communication components configured to enable the data retrieval device to communicate with and receive information from wireless-equipped recorders. Such wireless communication components may further enable the apparatus to communicate with and transmit information to a personal computer or suitable printer.

In another embodiment, a user may enter selected information by a keypad, touch screen, or other convenient input device. Such information may define a “trip” or other interval for monitoring and is communicated to a system for monitoring environmental conditions for the selected interval. Such communication may be wired, e.g. via USB or serial port (RS-232) or similar, or wireless, e.g. via cellular, radio frequency (RF), Bluetooth, or other comparable methods.

The present invention provides a user with unprecedented access to data from data recorders in arriving shipments, as well the ability to quickly and conveniently configure and initiate monitoring of outgoing shipments, or periods of time for stored products.

The apparatus employs integrated circuitry, including microprocessor or central processing unit, memory modules for data storage, and a rechargeable power supply. A display and desired lights, switches and buttons are applied for selected features. The integrated circuitry allows for execution of program instructions for communications protocols, control of data transfers to and from associated systems (data recorders, personal computers, monitoring systems, etc.), processing and analysis of collected data for communication and display to a user. Display of collected data may be in tabular, graphing, or other desired representation. Associated identifier codes or other information may be provided with displayed data to assist a user with identification.

A user may review data from any number of recorders, and in a number of presentation formats via simple input to controls on the apparatus.

The docking section of the data retrieval unit may preferably be outfitted with one or more flanges or sleeves, to allow convenient and guided insertion and connection of a selected data recorder. In the case of devices possessing radio frequency, infrared, Bluetooth, or similar wireless communication protocols, the docking section may serve to physically retain a data recorder, but actual physical electronic (wired) connectivity may not be required.

The data retrieval unit may preferably be equipped with radio frequency, Bluetooth, cellular, or other wireless communications to provide data retrieval capability from similarly equipped data recorders. In this event, the docking station may, if desired, function as a convenient holder for a selected data recorder. Depending upon wireless transmission conditions, a user may employ the data retrieval unit to poll nearby wireless-capable data recorders and retrieve multiple data sets wirelessly from multiple data recorders.

The data retrieval unit of the present invention can be used to gather and store data sets from dozens or even hundreds of data recorders, thereby providing a user with significant savings of time, effort, and expense compared to existing industry practices. Currently, a user must find and retrieve each individual data recorder and transport them to a central downloading/printing center to obtain the recorded data.

The data retrieval unit may similarly be equipped with infrared, Bluetooth or other wireless communication protocols to provide for data retrieval capability from similarly equipped data recorders. Even existing units with old-fashioned binary optical communications protocols may be accommodated if desired, by providing the data retrieval unit with suitable components for transmitting and receiving (transceiving).

The docking section of the data retrieval unit may be equipped with securing arrangements for retaining selected data retrieval units. Frictional, mechanical, magnetic, or other releasable securing methods allow temporary retention of selected data recorder and prevent unwanted or premature release of selected data recorder from said docking section. An associated release mechanism may be provided, if desired, to allow for undocking and removal of a data recorder upon completion of data retrieval.

The data retrieval unit is provided with integrated circuitry including at least one microprocessor (or CPU) for executing programmed sets of instructions and coordinating data input, storage, and output with memory modules configured in operable communication with said microprocessor.

One or more memory modules may serve to store operating instructions as well as data retrieved from data recorders. A power supply, preferably a rechargeable battery, is operably connected with said microprocessor, memory storage, visual display and control components, and desired connection ports, to enable functional operation.

Control component operations may be used to allow a user to scroll through retrieved data sets, change screen views to display a variety of tabular or graphic representations of selected data, and designate selected records for transfer or printing. Compact size is a beneficial aspect of the present invention, as it contributes to enhancing the portability of the device and providing handheld convenience to a user.

A portable handheld electronic data retrieval unit is provided for retrieving information from a data recorder and providing a user with selectable displays of information along with data storage and ability for subsequent transfer and/or printer. A user may browse data retrieved from one or more data recorders using a provided keypad or other control mechanisms. A variety of displays and data presentation formats are available to a user. Visual and/or audible indicators provide a user with notice of a retrieved data set that contained alarms or data not in compliance with pre-selected values.

The electronic data retrieval unit of the present invention provides a user with elapsed time at pre-established or user-selected temperatures or ranges of temperature. A variety of graphical representations of environmental conditions and time elapsed can be selected by a user for ready display. This capability allows a user to quickly ascertain the extent and effectiveness of environmental control and the severity of any transgression from desired conditions.

A data retrieval unit is presented that allow a user to quickly and reliably gather recorded data from multiple data recorder units. Each set of recorded data may be viewed instantaneously or recalled for later viewing. An indicator light, LED, or audible alarm may be used to signal or call attention to a data set containing an alarm condition or other selected parameter event. Such signaling may be achieved by providing a separate or dedicated audible or visible indicator, or by use of the unit's primary display.

A user may use the keyboard or keypad of the data retrieval unit to input information for association with one or more of data sets retrieved. Alternatively, a personal computer may be used to input such information. Bluetooth pairing or other wireless communications protocol may be employed to allow programming of said data retrieval unit and retrieval of collected data sets from said data retrieval unit.

Each set of recorded data retrieved from a data recorder is identified by, and associated with, a unique identifier value, allowing a user to retrieve data sets from multiple data recorders, quickly review the collected data in graphical or tabular format to ascertain any events of interest that may have occurred, and transfer selected or all collected data sets to a personal computer when convenient.

A user may employ the device to retrieve and review data from one or more data recorders before transferring selected or all retrieved sets of data to a remote computer for storage. Such transfer and additional communications with remote computer and/or printer equipment may be conducted through the incorporation of radio frequency transceiver communications, Bluetooth, or other wireless communication protocols. A user may clear selected data sets stored in the unit's memory from either the portable data retrieval unit or remote computer as desired. In addition, the data retrieval unit provides one or more of each of input and output communications ports of a type and arrangement to facilitate data recorders and data communications as are preferred and applied in the industry.

Apparatus in accordance with embodiments of the present invention can retrieve, process and display information regarding data sets of a number of data recording or monitoring devices or systems. Programming allows microprocessors to perform analysis of collected data sets and alert a user to any conditions that indicate a data error, corruption, tampering, or occurrence of conditions not within established parameter ranges. i.e., temperatures during transport that failed to remain within the desired/required range. Programming of said apparatus analyzes collected data sets and provides a user with a graphical, tabular, or text display of time elapsed for selected temperature units or ranges.

Apparatus in accordance with embodiments of the present invention can be configured to accept input from a user through a keypad, touch screen, buttons, or other of a variety of known input methods. A user may input data regarding a selected shipment or interval sought to be monitored. Such data may include identifying information, selected parameters for monitoring, selected ranges for such parameters, and additional descriptors as desired.

One preferred embodiment provides for a “starter” configuration in which the apparatus is configured for use primarily to initiate a monitored session or interval of a data recording system through communications with its control terminal.

The present device provides a self contained, compact, and portable instrument provided with microprocessor and memory storage for receiving, processing, and storing multiple retrieved data sets. Data may be stored in an electrical erasable programmable read only memory (EEPROM) or other comparable memory storage that is compatible with a computer for retrieving the time and temperature information, preferably a personal computer.

It is an object of the present invention to provide an apparatus for retrieving data sets from data recording devices.

It is another object of the present invention to provide a device for displaying, preferably graphically, data sets retrieved from data recording devices.

It is another object of the present invention to provide a device for displaying, in a manner selected by a user, data retrieved from data recording devices.

It is another object of the present invention to provide memory storage of data retrieved from data recording devices.

It is another object of the present invention to provide for transfer of data retrieved from data recording devices to a computer or printer.

It is yet another object of the present invention to provide detailed information or alarms, relating to events reflecting alteration in selected environmental parameters.

It is another object of the present invention to provide for wireless communication with data recorders and related monitoring systems.

In is another object of the present invention to provide a user with ability to define and initiate a selected interval for monitoring.

It is yet still another object of the present invention to provide a system as described above which is accurate, reliable, convenient, and provides coordination of recorded data with shipment tracking information.

The foregoing and various other objects and features of this invention will be apparent and fully understood from the following detailed description of the typical preferred forms and applications thereof, throughout which description reference is made to the accompanying drawings.

### BRIEF DESCRIPTION OF THE DRAWINGS

A better understanding of the present invention may be realized from a consideration of the following detailed description, taken in conjunction with the accompanying drawings, in which:

FIG. 1 is a front view of one particular arrangement of a data retrieval unit in accordance with the present invention and depicting a sample of a retrieved data set;

FIG. 2 is a sample representation of one arrangement of user selectable displays for a data retrieval unit of the present invention;

FIG. 3 is front view of one particular arrangement of a data retrieval unit in accordance with the present invention in cooperation with a representation of a sample data recorder unit commonly used in industry, depicting the sample data recorder unit positioned to be docked with the data retrieval unit;

FIG. 4 is a block diagram representing a functional configuration of components in accordance with the present invention.

FIG. 5 is a block diagram representing a configuration of functional elements and embodiments of the present invention.

FIG. 6 is a combination flow chart and block diagram depicting elements and processes of the communications and interactions of the present invention.

### DETAILED DESCRIPTION OF THE PREFERRED EMBODIMENTS OF THE INVENTION

Referring now to the drawings, apparatus for data recording systems in accordance with embodiments of the present invention are illustrated. Various aspects of the present invention will emerge from the following detailed description of the preferred embodiments in reference to the drawings previously described.

This apparatus for data recording systems can be variously configured to address the needs of a broad variety of applications. A handheld or portable device, it provides a user with the ability to retrieve data sets from a number of data recorders and system monitors using wireless communications or employing a docking station provided on the apparatus.

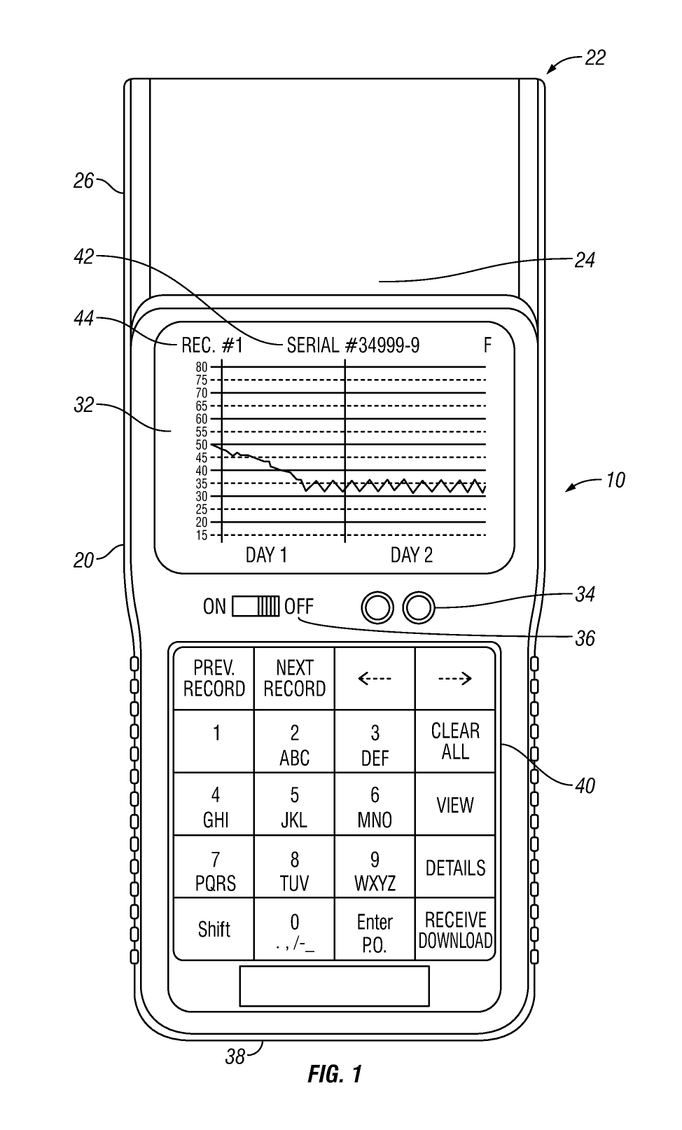

Turning now to FIG. 1, an apparatus for data recording systems in accordance with an embodiment of the present invention is illustrated and depicted as data retrieval unit 10. Data retrieval unit 10 is depicted having a body (or case) 20 to retain and protect components, and a liquid crystal module (LCM) display 32 depicting a representation of a selected data set collected from a data retrieval unit. Display 32 is not restricted to a LCM. Liquid crystal displays (LCD), light emitting diode (LED), or other capable displays are contemplated. Pixilated displays are preferable but not mandatory. Attached to, or formed integrally with, body 20 is docking section 22 adapted to receive a monitoring device X, such as a temperature or other data recorder. Said docking section 22 may employ an elevated perimeter 26 defining a flange or sleeve at least partially encompassing a recessed area for receiving a monitoring device. Docking section 22 may alternately employ any of a variety of arrangements that serve to retain a monitoring device to facilitate communications. Mechanical latches, clips, or frictional arrangements well known in the art enable docking section 22 to selectively retain a monitoring device for data communications. Communications connector 24 is arranged in cooperation with docking section 22 to provide operable communication with a data recorder positioned at said docking station 22 for data retrieval. Communications connector 24 may serve to retain a monitoring device and thereby function as docking section 22 if desired. Display 32 is arranged in body 20 for ready viewing. Similarly, signal indicators 34 and control panel 36 are provided. Indicators 34 may be LEDs, lights, sound generators or other well known signaling components. Switch 36 may incorporate one or more buttons, switches, or other well known switching components. Control panel 40 provides a keypad, touch screen, or other convenient interface. One or more additional data ports 38 are provided to accommodate a variety of protocols for communicating with a personal computer. Such data ports 38 may be wired, e.g. USB, DB-9, etc., or wireless, e.g., wi-fi, RF, IR, etc. Control means 40 is accessible within body 20 to provide desired user access. Said control means 40 is preferably an alphanumeric keypad or touch screen to enable a wide range of convenient input opportunities for a user.

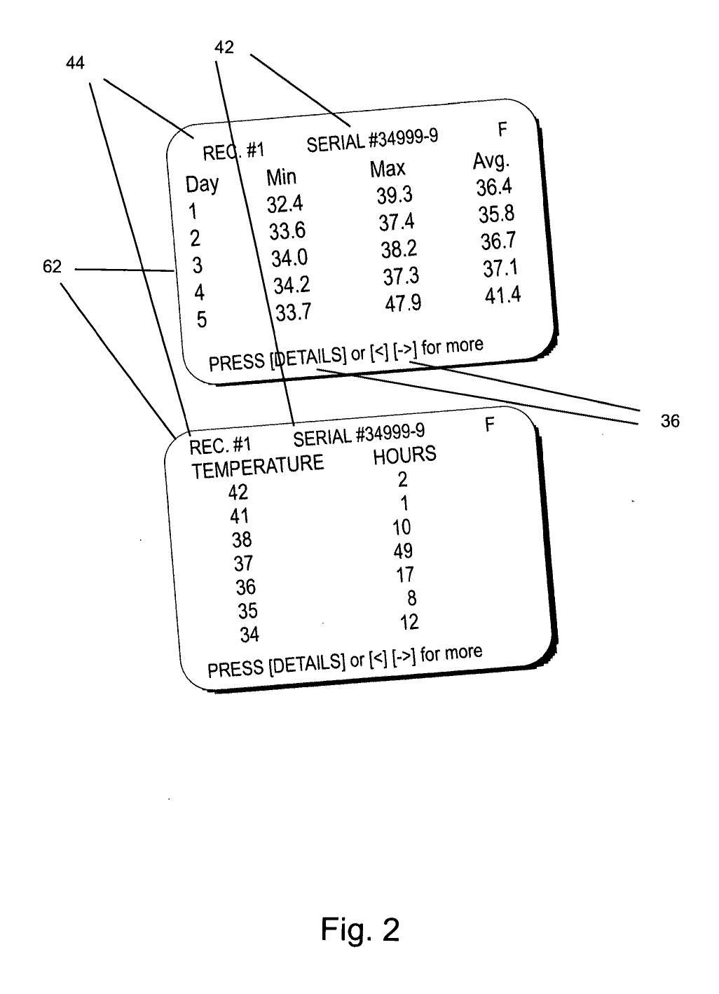

FIG. 2 is a representation of sample displays of arrangements of data as are to provided to a user via visual display components 32. User selectable displays, alternating displays, and scrolling displays are contemplated. Representative sample displays 62 for visual display 32 incorporate arrangements of data identifier values 42 (e.g., shipment, customer, goods, etc.) and recorder device identifier values 44 (e.g., serial number). Additionally, instructions 36 may be provided to assist a user. As depicted in FIG. 2, visual display 32 allows data retrieval unit 10 to present a variety of data presentations. Sample data presentations are shown. Identifier codes 42 may be provided to differentiate multiple sets of retrieved data. Similarly, device identifiers 44 may be displayed to indicate a particular source of a selected data set. Device identifier 44 most often represents a unique number or code for a particular data recorder or system.

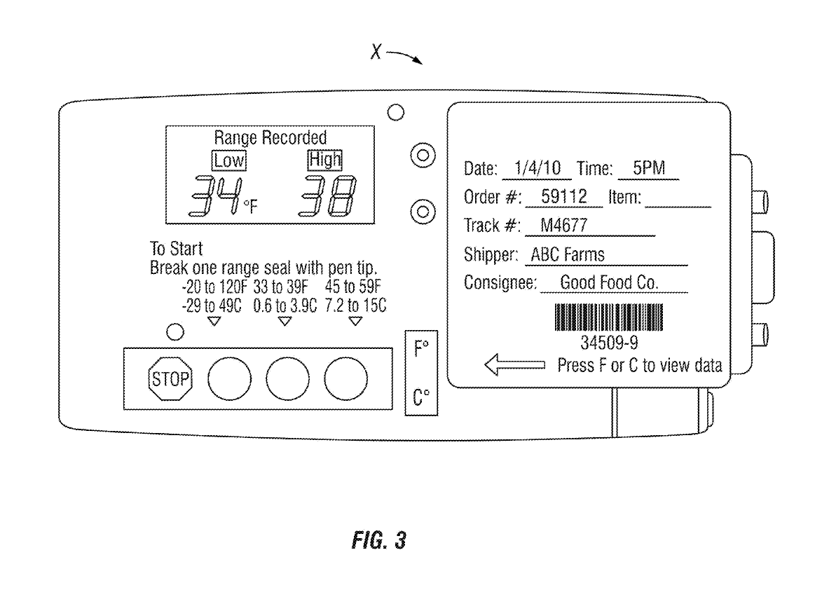

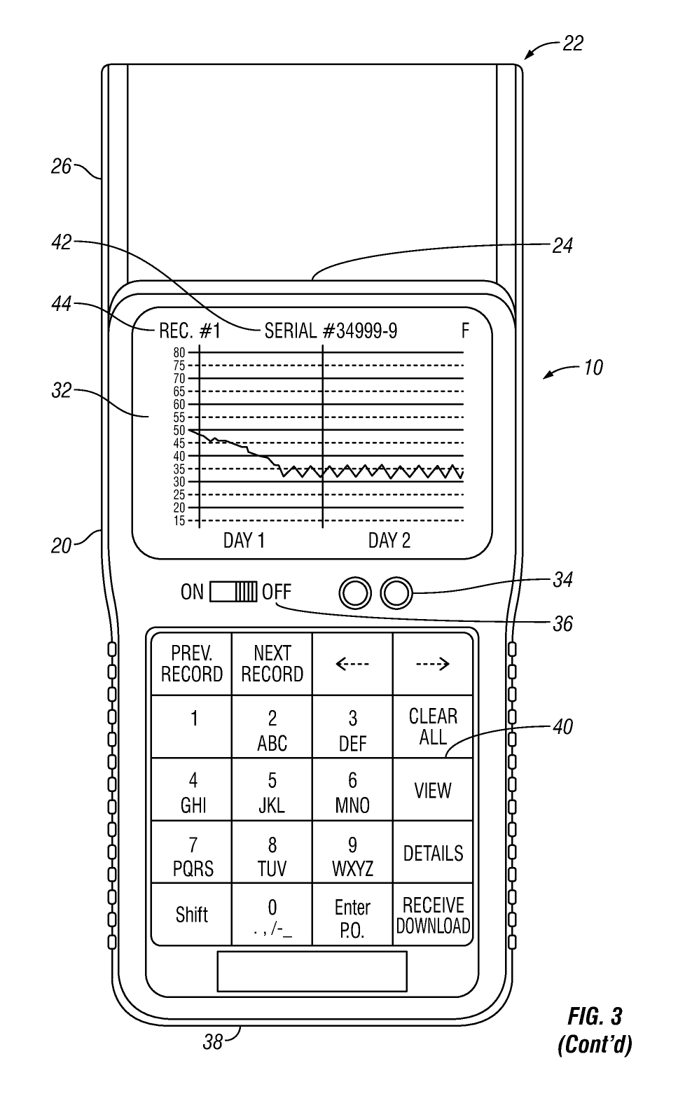

FIG. 3 is a representation of a data retrieval unit 10 of the present invention, similarly depicted in FIG. 1, with a representative sample data recorder unit in close proximity to docking section 22. Sample data recorder unit is depicted in preparation for docking and subsequent transfer of recorded data via data port/communication connector 24 within raised perimeter portion 26 of docking section 22.

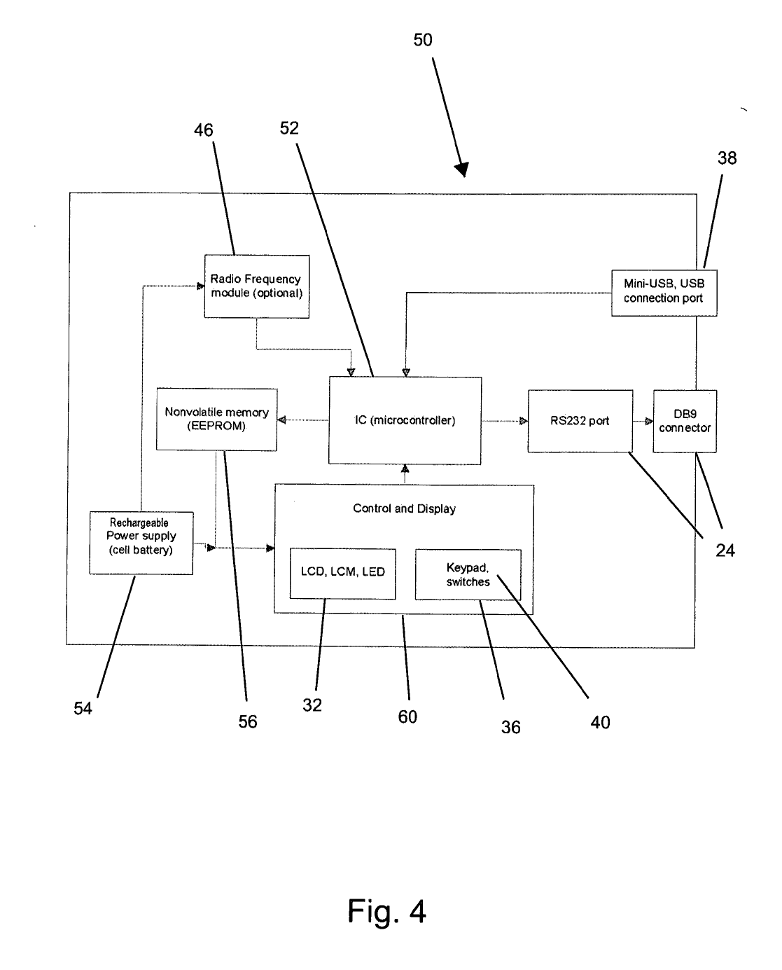

FIG. 4 is a plan view of a block diagram of the functional components of circuitry 50 operably arranged for a particular arrangement of said data retrieval unit 10 in accordance with the present invention. Communication connector 24 is provided for enabling communication with data recorders and allowing transfer of selected data. Data port 38 is provided to enable communication and transfer of data to a personal computer. Wireless communication means 46 is operably connected in circuitry 50 to enable wireless communications to enhance capabilities for data retrieval and transfer. Circuitry 50 includes at least one microprocessor 52 for executing programming instructions and executing necessary computational and associated operations. Memory storage 56 provides memory modules for storing data and programmed instructions as necessary. Control and display module 60 incorporates visual display components 32, switches 36 and data entry keypad or keyboard control means 40, as appropriate for desired configuration of the device 10. Power supply 54 is in operable communication with memory 56, control and display components 60, radio frequency module 46 and microprocessor 52 as necessary to carry out programming, execution of instructions, data transfers, processing operations, and associated display features of said device. Circuitry 50 is arranged in protective body 20, allowing external access to data port 38, communication connector 24, control panel 40, and visual display components 60 to provide effective and convenient access to a user. In use, control components and display components 60 afford user an interface for entering desired customized parameters such as name, location, product, shipper, etc. Such information may be transferred to said data retrieval unit 10 via remote computer if desired. A user operably connects a data recording device to communication connector 24 and, as detected and instructed by programming instructions, initiation of data collection is undertaken. Collected data is processed in accordance with programming instructions to present, via visual display components 32, a variety of selected data representations and summaries. Data port 38 allows automatic initiation of transfer of selected data sets to a remote personal computer. Such communications may be performed wirelessly is desired.

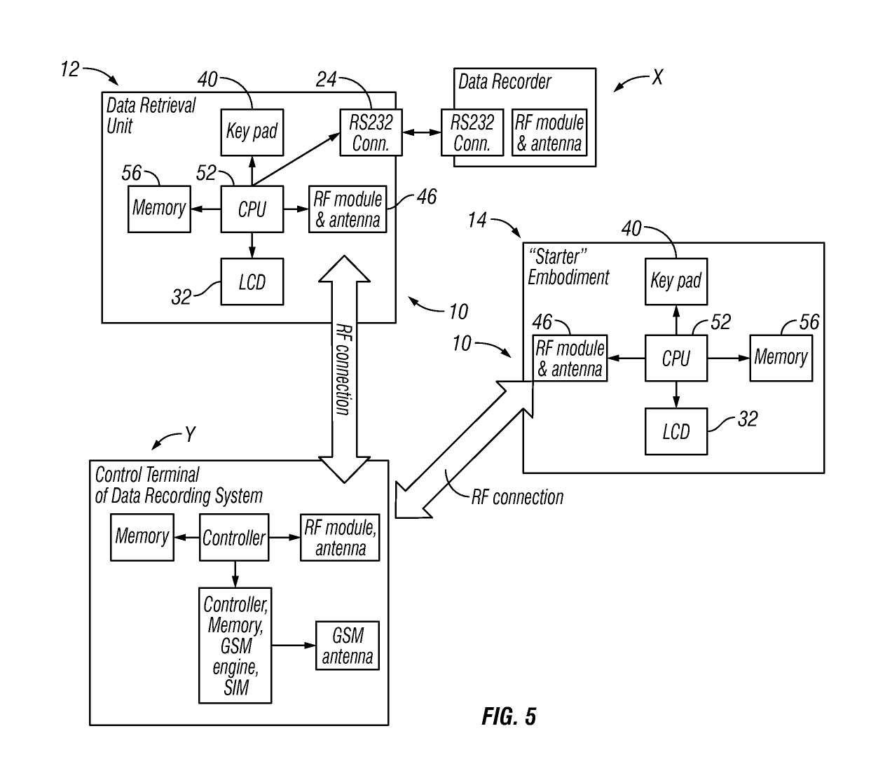

FIG. 5 is a block diagram representing an arrangement of preferred embodiments of the present invention in cooperation with representation of potential applications for interaction and data exchange. One preferred embodiment is data retrieval unit having a standard configuration 12 for receiving data recorders X by way of communication connector 24 for communication and collection of recorded data from data recorders X. A second preferred embodiment provides a “starter” configuration 14 in which the apparatus is configured for use primarily to initiate a monitored session or interval of a data recording system through wireless communications with the control terminal Y of a desired data recording system. RF module 46 provides microprocessor or “CPU” 52 with wireless communication of information. Both embodiments 12 and 14 provide control means 40, shown here as a keypad, to allow input by a user. Processing and analysis of data retrieved from data recorders X is provided by microprocessor 52 and memory storage 56. Programming of necessary software is well known to those skilled in the art and may be achieved in a variety of ways.

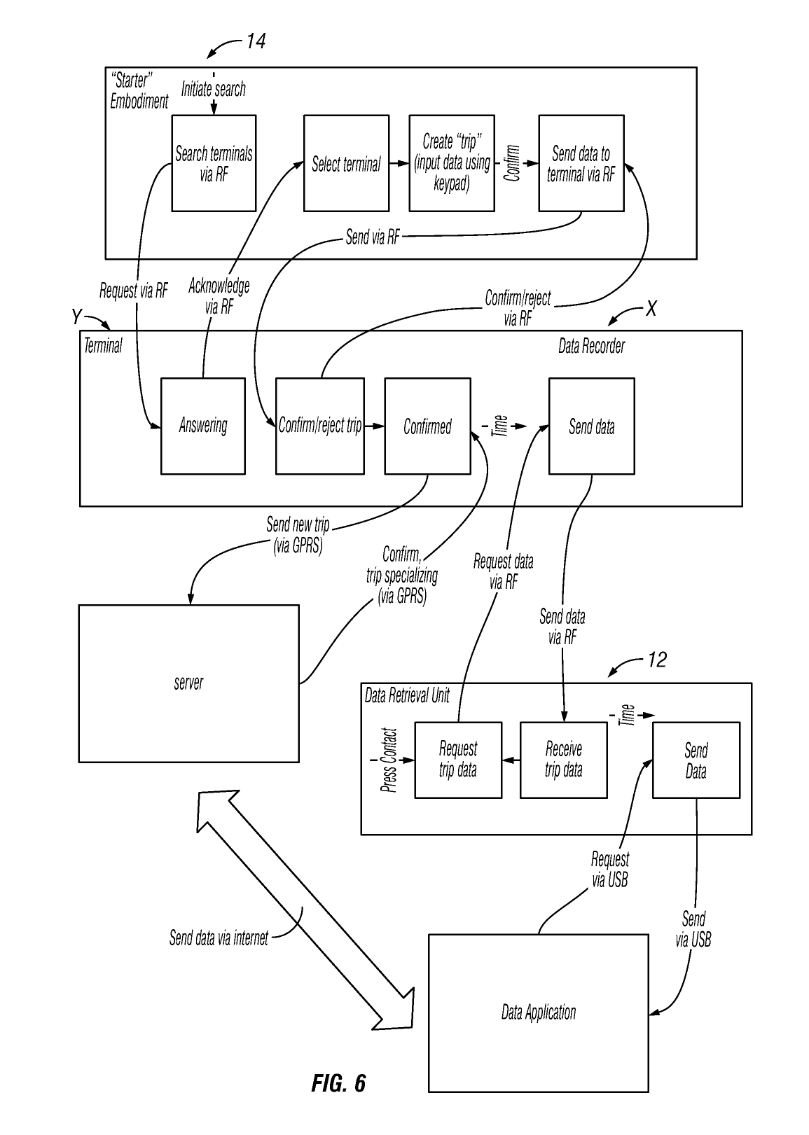

FIG. 6 is a combination flow chart and block diagram depicting elements of the present invention and preferred embodiments for the process of communication and interaction with subject devices and systems. One preferred embodiment is a data retrieval unit having a standard configuration 12 for wirelessly receiving data sets from data recorders X. A second preferred embodiment provides a “starter” configuration or mode 14 in which the apparatus is configured for use primarily to initiate a monitored session or interval of a data recording system through wireless communications with the control terminal Y of a desired data recording system. After receiving user input relating to a session or interval to be monitored, the apparatus proceeds to scan for suitable receiving terminals. Such control terminals may be associated with data recording systems for a shipment of perishable goods ready to depart for transport, an area of a facility sought to be monitored, or any of a variety of applications. Upon identifying and selecting the desired terminal Y, the unit 14 programs the terminal to reflect the requirements of a user. Confirmation of the terminal's receipt and verification of the programming data is provided for review by a user. Upon confirmation, the monitored interval is initiated in accordance with programmed instructions.

Although there have been described hereinabove various specific arrangements of a APPARATUS FOR RETRIEVAL, STORAGE, AND DISPLAY OF DATA FROM DATA RECORDER SYSTEMS in accordance with the present invention for the purpose of illustrating the manner in which the invention may be used to advantage, it will be appreciated that the invention is not limited thereto. Accordingly, any and all modifications, variations, or equivalent arrangements, which may occur to those skilled in the art, should be considered to be within the scope of the invention as defined.

What is claimed is:

1. A portable apparatus for retrieval, storage, and display of collected environmental parameter data from data recording systems or devices, said apparatus comprising:
a protective body sufficiently surrounding and retaining components;
a docking section for receiving data recording devices;
at least one communication connector adapted to interface with desired data recording device for data transmission;
a control and display module for allowing user input and outputting information to a user;
at least one data port for exchanging data with a computer;
associated circuitry adapted and programmed for performing necessary processing and control to locate, identify, communicate with, and retrieve selected data sets from selected devices, and further performing programmed analysis and processing of retrieved data, said circuitry having;
a. a microprocessor for executing programmed instructions and coordinating data input, storage and output, in operable communication with said communication connector, said data port, and said control and display module;
b. a memory module in operable communication with said microprocessor for storing data and instructions;
c. a power supply in operable communication with said microprocessor, said memory module, said control and display module, and said display.

2. The apparatus of claim 1, further comprising wireless communication means for enhancing capabilities for data retrieval and transfer.

3. The apparatus of claim 2, wherein said wireless communication means comprises a radio frequency module.

4. The apparatus of claim 2, wherein said control and display module comprises a visual display for presenting information to a user and a control panel allowing user input.

5. The apparatus of claim 4, wherein said visual display comprises a liquid crystal display.

6. The apparatus of claim 1, wherein said control and display module further comprises visual display components, switches, and keypad allowing for user input and selection.

7. The apparatus of claim 1, wherein said control and display module comprises a touch screen for displaying selected information and allowing input.

8. The apparatus of claim 1, wherein said power supply comprises rechargeable batteries.

9. The apparatus of claim 1, wherein said apparatus is operative in an additional capacity or alternatively selected mode in which said apparatus may initiate selected data monitoring and recording as input by a user.

10. A portable apparatus for retrieval, storage, and display of collected environmental parameter data from data recording systems or devices comprising:
a protective body sufficiently surrounding and retaining components;
a control and display module for allowing user input and outputting information to a user;
wireless communication means for initiating selected monitoring by a data recording system;
associated circuitry adapted and programmed for performing necessary processing and control to locate, identify, select, transfer and receive data to initiate selected monitoring by communicating with a control terminal for a data recording system, said circuitry having;
a. a microprocessor for executing programmed instructions and coordinating data input, storage and output, in operable communication with said wireless communication means; and said control and display module;
b. a memory module in operable communication with said microprocessor for storing data and instructions;
c. a power supply in operable communication with said microprocessor, said memory module, said control and display module, and said display.

11. The apparatus of claim 8, wherein said wireless communication means comprises a radio frequency module.

12. The apparatus of claim 8, wherein said control and display module comprises a visual display for presenting information to a user and a control panel allowing user input.

13. The apparatus of claim 10, wherein said visual display comprises a liquid crystal display.

14. The apparatus of claim 8, wherein said control and display module further comprises visual display components, switches, and keypad allowing for user input and selection.

15. The apparatus of claim 8, wherein said control and display module comprises a touch screen for displaying selected information and allowing input.

16. The apparatus of claim 8, wherein said power supply comprises rechargeable batteries.
